(19) United States
(12) Patent Application Publication
(10) Pub. No.: US 2017/0024088 A1
(43) Pub. Date: Jan. 26, 2017

(54) Emergency Incident Data Structure Creation and Analysis

(71) Applicant: Digital Praetorian, Inc., Corona, CA (US)

(72) Inventors: Michael Alan La Pean, Corona, CA (US); Alison Lee La Pean, Corona, CA (US); Siripat Chaichan, Gardena, CA (US)

(21) Appl. No.: 15/218,000

(22) Filed: Jul. 23, 2016

Related U.S. Application Data
(60) Provisional application No. 62/196,425, filed on Jul. 24, 2015.

(51) Int. Cl. G06F 3/0482; H04W 4/22; G06F 17/24; H04M 1/725

(52) U.S. Cl. CPC G06F 3/0482; H04M 1/72536; H04W 4/22; G06F 17/245; H04M 2201/42; H04M 2250/68

(57) ABSTRACT

A computer-based method of collecting, organizing, and distributing data related to an emergency event includes presenting a GUI on a mobile electronic device that includes a selectable element to provide information about a disaster event, and a selectable element to provide information about a violence event. In response to a selection, another GUI is presented that includes at least one pre-defined field for user input that is customized to the selected element. Information about the emergency incident is collected and sent to a server where it is stored in a database with other information about the event. The server retrieves information from the database and sends it to a second electronic device. A first portion of the information is displayed in a first format on the second electronic device, and a second portion of the information is displayed in a second format.

### CROSS-REFERENCE TO RELATED APPLICATIONS

This application claims the benefit of U.S. Provisional Patent Application No. 62/196,425, entitled Emergency Incident Data Structure Creation and Analysis, filed on Jul. 24, 2015, which is incorporated by reference herein in its entirety for any and all purposes.

### BACKGROUND

Technical Field

The present subject matter relates to the field of reporting, communicating, and managing data related to an event. More particularly, it relates to reporting, communicating, and managing data related to an emergency incident, such as a disaster or an incidence of violence.

Background Art

It is an unfortunate reality that emergency incidents, both natural and man-made, are all-too-common events in modern life. Disasters, such as earthquakes, fires, floods, tornadoes, hurricanes, tsunamis, gas leaks, downed electrical wires, and other natural or man-made disasters, have occurred throughout human history, and can occur with or without warning. Disasters can affect regions and populations of vastly different size and scope, from a single dwelling, to an entire region, depending on the type and severity of the disaster. Incidents of violence have seemingly become more common in recent years, with many examples of workplace violence, school shootings, and terrorist actions against so-called “soft targets” such as outdoor gatherings, shopping malls, churches, bars, and restaurants.

First responders, such as police and fire fighters, often find a chaotic scene where very little information has been gathered, cataloged, and managed, even though many witnesses to the disaster or violent incident have important information that would be of great value in assessing the scene and making a determination of how to manage the incident. With the widescale adoption of smartphones, a large percentage of people that are eyewitnesses to the event have the technology in their pocket to be able to report on the incident as it is unfolding, and many people do just that, posting pictures and descriptions on various social media sites. This information is very difficult to collate and use by first responders, however, as the data is not centralized and can be difficult to find and interpret.

### BRIEF DESCRIPTION OF THE DRAWINGS

The accompanying drawings, which are incorporated in and constitute part of the specification, illustrate various embodiments. Together with the detailed description, the drawings serve to explain various principles. In the drawings:

FIG. 1 shows an embodiment of a system for emergency incident data management;

FIG. 2 shows a block diagram of a mobile electronic device suitable for various embodiments;

FIG. 3 shows a block diagram of an electronic device suitable for various embodiments;

FIG. 4A-4H show example graphical user interface screens of an embodiment of a reporter application on a mobile electronic device;

FIG. 5A-5F show example graphical user interface screens of an embodiment of an incident manager application on an electronic device;

FIG. 6 is a flowchart of an embodiment of a reporter application;

FIG. 7 is a flowchart of an embodiment of a server application; and

FIG. 8 is a flowchart of an embodiment of an incident manager application.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Some descriptive terms and phrases are presented in the following paragraphs for clarity.

The words “incident,” “situation,” and “event” are used interchangeable herein and therefore “emergency incident,” “emergency situation,” and “emergency event” are also considered synonyms herein. An emergency incident/situation/event can be any type of occurrence where an emergency response it required, including natural disasters, man-made disasters, violent events, terrorist incidents, crimes, or events that cause a person to believe that an emergency incident may be taking place.

A user is a person interacting with the system. In general, a reporting user is an individual that is using a mobile electronic device to provide first-hand information about an emergency incident to the system. Various other terms may also be used to describe such an individual, such as teacher, employee, witness, on-scene emergency responder, and others. An incident manager user is a user that is receiving the information from the reporting users. Various other terms may also be used to describe such an individual such as administrator, principal, security supervisor, and others. In some cases, a single individual may function in both capacities, but may utilize different applications, or different user interfaces within a single application, depending on the function being performed.

The word “present” and its various forms, including “presenting” and “presentation,” can refer to any method of providing information to an individual. While the word may be narrowed in some instances, such as “presenting a GUI on a display,” in general the word should be interpreted to cover a visual presentation of information, an audible presentation of information, or any other way of presenting information perceivable by the senses of a human being.

The various embodiments described herein include various components of a computer system configured to allow for communicating during an emergency by providing emergency incident status reports and providing an optimal response. Components include individual electronic devices, methods used by those electronic devices, computer-readable media to hold instructions executable by a processor in the electronic devices to perform those methods, and the overall system. The system provides mechanisms for reporting users to provide a range of status reports, ranging from simple to detailed, using predefined fields. Incident manager users can receive these reports in an easily readable and sortable format, and may provide confirmation of the reports or request additional information from the reporting users. The reports available to the incident manager users include reports that display the location of the reporting party and the incident details using one, or a combination of, mapping (or cartographic) methodologies, including, but not limited to, a simple map grid system, “beacon” technologies, or GPS technology. The incident manager reports can also include totals from all incident reports together in a viewable and manageable manner, allowing administrators who have the proper authority, to view, sort, and manage the incident using updates on the emergency situation. Some embodiments include a user interface on an electronic device to show the incident status reports to an incident manager user, including identifying those reports which have been acted upon and those reports which still have not yet been acted on. This allow is the incident manager user to determine if action is warranted and prudent. Various other graphic user interfaces (GUIs) may display a directory of all maps of the organization available for view, and whether they are affected by the incident or not. GUIs for incident manager users may also display, update and provide for the entry of new instructions/directions to be followed during an emergency incident, and GUIs for reporting users may display those instructions as appropriate. Some embodiments allow both a high level and a detailed status of an organization and any sub-organizations within that organization, and provide for sending messages to individual reporting parties or groups in response for their status reports.

In at least one embodiment, a mobile application is provided in advance to a person, such as a teacher or employee, which may be involved in, or subjected to, an emergency event. The mobile application may be installed on the individual's personal smartphone, such as a Samsung® phone running the Android® operating system from Google® or an Apple iPhone®, or the individual may be provided with a mobile electronics device that runs the mobile application. The mobile application allows the person to send a status report to an administrator that provides details of an emergency incident, should one occur, from that person's perspective and provide details about that person's current situation. A graphical user interface (GUI) allows the reporting party to specify the type of emergency incident and any details about that incident using predefined fields. Additional embodiments provide for an application that allow an administrator, or incident manager, to view, sort, map, store, record, report on or respond with information or questions for the reporting party.

While useful for many environments, some embodiments are adapted for use in an educational environment to provide school administrators, teachers, and staff with enhanced communication and reporting capabilities. Another embodiment is adapted for private enterprise use by employees, security personnel, organizational emergency response teams, management and executive management to provide enhanced communications and reporting capabilities.

Individuals with many different roles within an organization, such as security personnel, emergency response teams, executive management, employees, teachers, administrators, managers, and consultants, experience emergency situations where information provided from those involved can and will be found useful during an emergency incident. While phones, both cellular and landline telephones, as well as two way radios, have traditionally been used as the primary means of reporting emergencies and relaying status reports related to an emergency, current technology, including smart phones, tablets, computers, SMS messaging, text messaging, cellular telecommunications data networks, email, “beacon” location technologies, Bluetooth, wireless Wi-Fi networking, and the like, allow for much more efficient and complete reporting of status during an emergency incident. Using these technologies allows both the members of an organization, including their security services, as well as emergency response personnel, such as fire, police and emergency medical services (EMS), to obtain a better “picture” of the emergency by allowing them to make decisions based on those status reports. Embodiments are intended to assist in the management of an emergency incident, whether it be a school shooting, a workplace violence incident, or a natural disaster such as an earthquake or tornado.

One of the things most lacking in an emergency is a holistic view of the entire incident. This fact makes decision making for all people involved more difficult and results in some educated guesswork on the part of all responsible parties when making decisions on how to best handle the incident. This fact is true not only for the personnel, management, administration and executive management of businesses, schools and other organizations, but is also true of the emergency response personnel. By providing real time status reports from multiple sources (a form of crowd sourcing) through an emergency incident management software application that is portable and operable on widely used electronic devices, such as smart phones and tablets, an emergency incident becomes much more manageable and allows the appropriate decision makers to make decisions from a position of knowledge rather than forced ignorance.

Without improvements to the current methodologies, processes, and systems for communicating between management, employees/volunteers, and local emergency personnel during an emergency incident, the ability to effectively respond to an emergency incident will continue to be sub-optimal. The ability to effectively respond requires monitoring the incident, planning responses to the incident, sending meaningful and appropriate communication to those that should be alerted in a timely manner, and initiating an appropriate response, all of which are very difficult today due to limitations of current systems, procedures, and methods for communicating during an emergency incident.

Various embodiments allow for reporting of status during an emergency incident and for the accumulation of status reports for the purpose of providing a view of the incident for planning and actions based on those reports. The system focuses on providing a user interface for a reporting party, such as a teacher or employee, to communicate to a superior, such as an administrator or manager, the status of their person, classroom (surroundings) and children (other people) during an emergency, and for an administrator to use the accumulated status reports to act, plan and coordinate responses from the administration, local first responders, or other emergency personnel. Embodiments allow for communicating with various people in the organization and also may include communicating with the public.

Various embodiments may be specifically targeted at a particular type of entity. Embodiments may provide a reporting party with options for emergency types that are tailored to the particular type of entity. The embodiments may also allow for status updates with pre-defined fields appropriate for that type of entity and emergency event. Incident managers may be provided with credentials that limit the type of information available to them based on their responsibilities and capabilities. Various embodiments may be specifically designed for use by community school districts, urban school districts, universities, community groups, individual businesses, manufacturing plants, refineries, shopping malls, municipalities, and government agencies, among others, to send and receive communications relating to an emergency situation with specific options tailored to that environment. For example, a system tailored for a school may include the option for initiating a school lockdown, but a system tailored for a manufacturing plant may include an option for an emergency assembly line shutdown, where neither option would be appropriate for the other type of entity.

Some embodiments are targeted at an educational environment, such as a community school system, and allow a reporting party, such as a teacher, to report on his or her status in relation to an emergency incident to an administrator, such as the principal or a superintendent, using a smartphone or tablet that the teacher already has with them nearly all of the time and is comfortable using. An administrator can then use another electronic device to receive status reports from various teachers in the school system. These status reports may include, but are not limited to, the type of incident, the location of the incident, the name of reporting party, the location of reporting party, the date and time, the safety of the reporting party, the number of other people with the reporting party, information about any injured people, and other details of the incident. The administrator can then begin to try to manage the situation and coordinate a response with outside emergency responders. Similarly, some embodiments are targeted at corporate environments to allow employees to report on emergency incidents and to allow corporate management and security personnel to manage the situation and coordinate a response with outside emergency responders.

Specific elements of the GUI may include the ability to select the nature of the emergency situation, such as a disaster or an incidence of violence. Some embodiments may provide the ability to select from a menu of specific types of disasters or violent events to provide further clarity on the situation. Predefined fields specific to the event allow the reporting individual to easy include information important to the incident manager, such as a number of trapped individuals, a number of injured people, the location of an assailant, and other details. This allows the incident manager to plan an appropriate response to the emergency incident. Specifically, some embodiments provide for a user interface on a mobile electronics device which allows reporting users to efficiently send details of the immediate emergency incident in the form of a status report. The details may be entered by pressing predefined buttons that correspond to the type of the emergency incident. The details are then sent to a server application, and an incident manager user can then view, monitor, record, track, and respond to, multiple status reports, using another a user interface on an electronic device that also communicates with the server.

Various embodiments include computer programs to run on a server and instruct the server to create and modify databases, track, update and store data received as status reports from reporting parties, configure and implement various search and retrieve functions for a multitude of search incident status reports, send information to incident manager users, validate credentials received from various users and determine permissions for those users based on the credentials, send commands to controllable devices based on pre-defined rules, and update and transmit reports based on the status reports which have been received from reporting parties. Appropriate entities (e.g. business owners, managers, administrators, teachers, staff members, security, emergency response teams, safety teams, and the like) can utilize the computer program running on the server to initiate and complete a wide variety of database-related applications for the provision of status reports and any communications between users during a perceived emergency situation or an actual emergency situation.

It should also be noted that several embodiments include the use of mobile application software executed by a mobile device. In all of these cases, the use of mobile application software executed by a mobile device is optional and may or may not be used for sending and receiving incident status reports. In some embodiments, incident managers and reporting parties use software accessed via a browser on an electronic device, such as a smartphone, tablet, laptop computer, or desktop computer, to send and receive status reports detailing the local and immediate conditions, such as providing detailed information for planning and knowledge purposes to any incident managers or emergency personnel that are managing the emergency incident.

Reference now is made in detail to the examples illustrated in the accompanying drawings and discussed below.

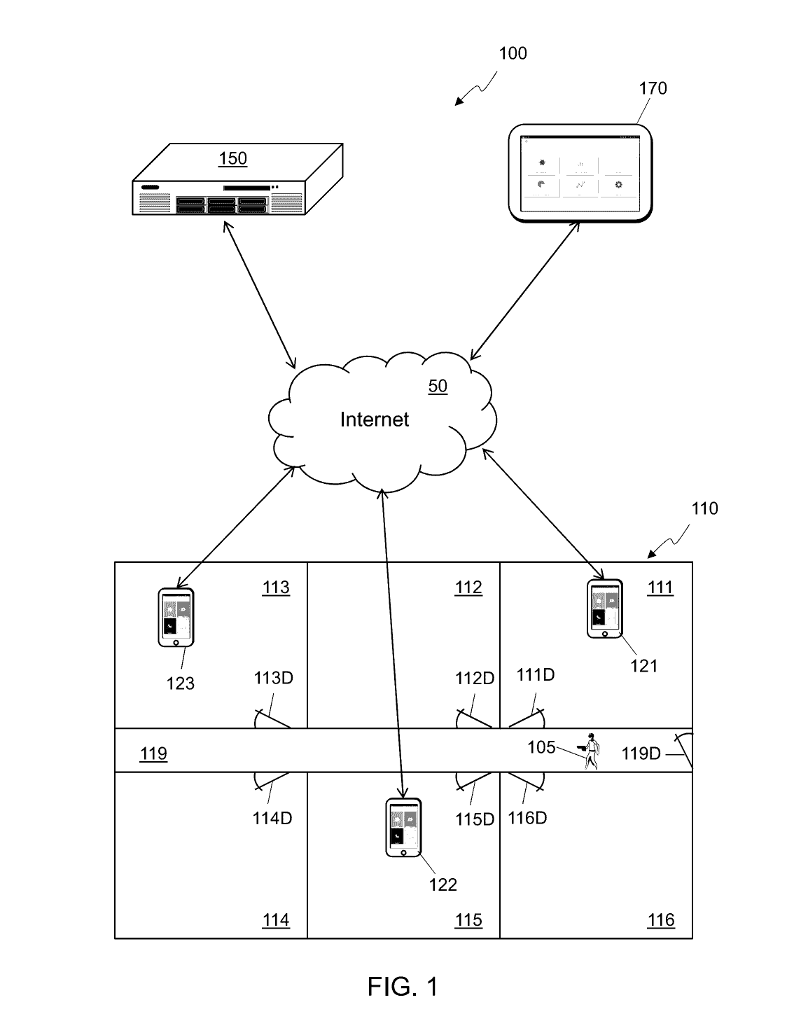

FIG. 1 shows an embodiment of a system 100 for emergency incident data management. The system 100 can be used for a computer-based method of collecting, organizing, and distributing, data related to an emergency situation. The system 100 includes one or more mobile electronic devices 121-123 that may be used to report information from the emergency situation. The mobile electronics devices 121-123 of this embodiment may be any kind of mobile electronics device such as a smartphone, a tablet, a laptop computer, a purpose-built mobile electronics device, or any other type of electronics device capable of displaying a graphical user interface (GUI) and communicating over a network or other communications link to the server 150. The mobile electronic devices 121-123 can be used by individuals that are near the emergency situation and may be able to see, feel, hear, or otherwise sense, various aspects of the emergency situation and use the mobile electronic devices 121-123 to report on the emergency situation. In some embodiments, other on-scene users may use other types of electronics devices, such as a desktop computer, a wall-mounted control panel display, or a purpose-built non-mobile electronics device to report on the emergency situation. In the example shown, the mobile electronic devices 121-123 are in the possession of individuals located in a building 110, which may be a school, office, business, shopping mall, or other type of building. In other emergency situations, the individuals using a mobile electronic device may not be in a building, but may be outdoors, or in a vehicle.

In the example of FIG. 1, the building 110 has six rooms 111-116, and each room has a door 111D-116D into a hallway 119 which has a door 119D to the exterior of the building 110. An individual with a first mobile electronics device 121 is located in the first room 111, a second individual with a second mobile electronics device 122 is located in the fifth room 115, and a third individual with a third mobile electronics device 123 is located in the third room 113. An intruder 105, in possession of a gun, has entered through the exterior door 119D into the hallway 119 of the building 110. The first individual, in this example, is the first to notice the intruder 105 due to the proximity of the first room 111 to the exterior door 119D. The first individual may then use the first mobile electronics device 121 to report on the emergency situation.

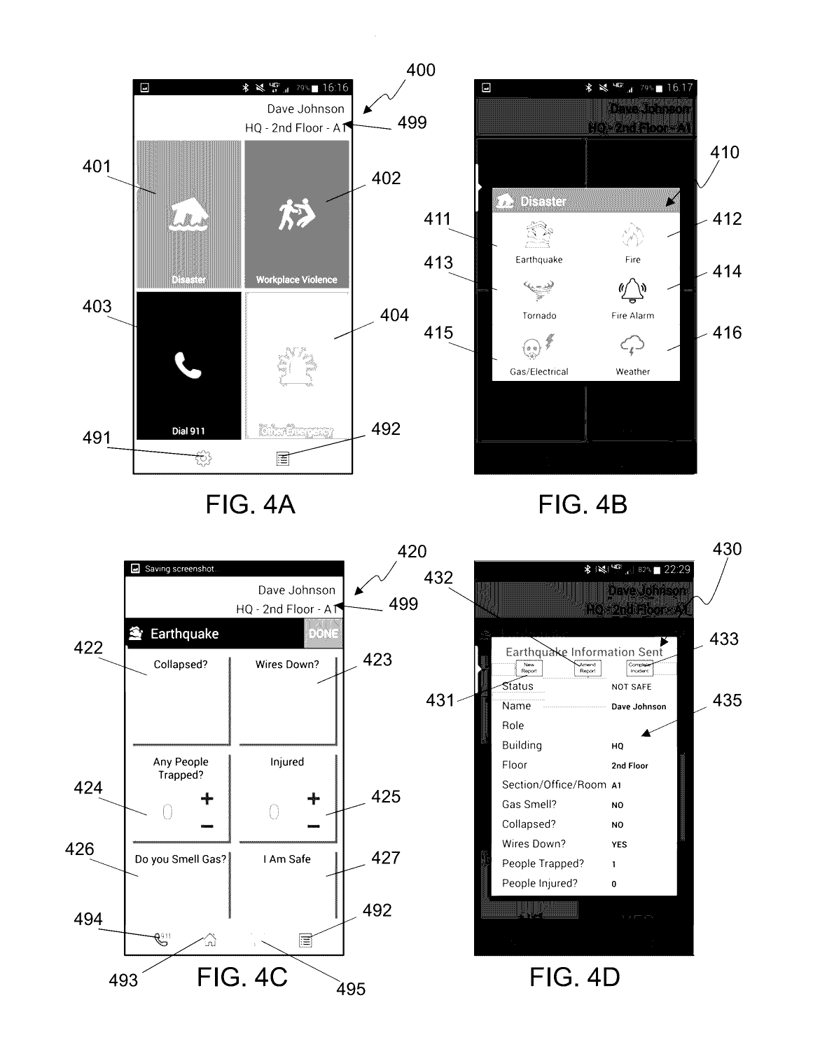

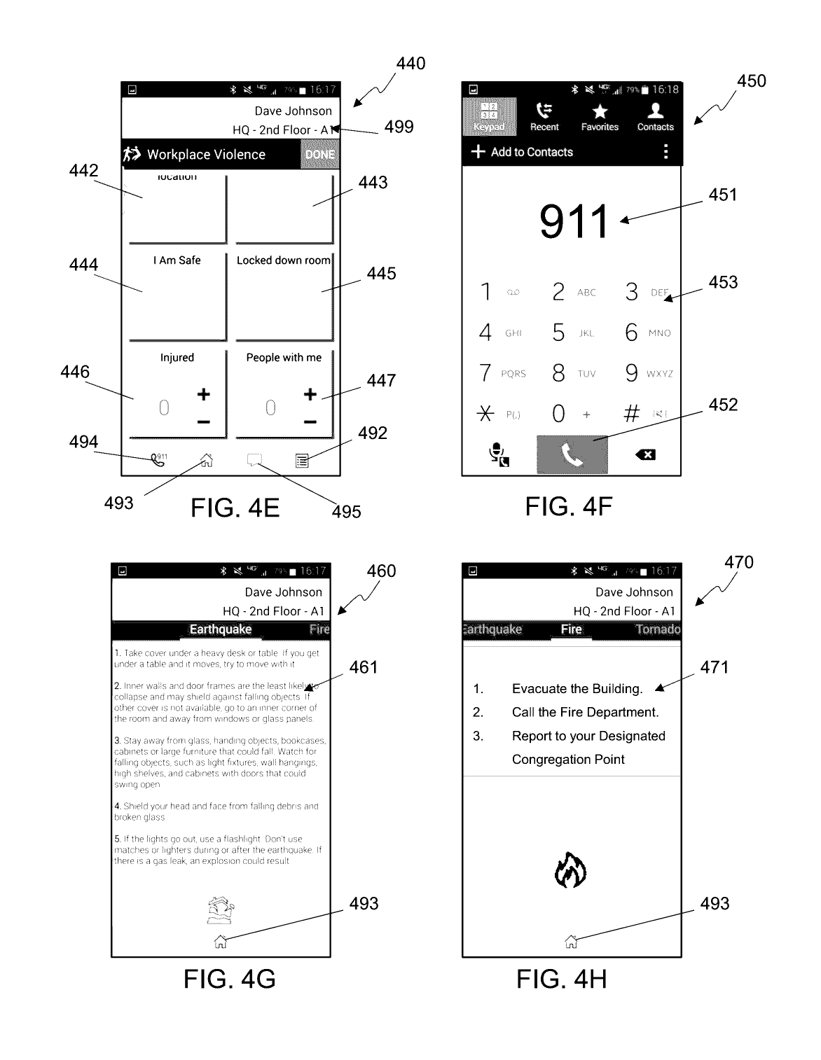

As a part of the reporting process, the first mobile electronics device 121 presents a first graphical user interface (GUI). An example of the first GUI is shown in FIG. 4A, although various embodiments may have very different looking GUIs depending on their particular needs, the characteristics of the mobile electronic device, and other factors. The first GUI may be presented by an application (or app) that has been installed on the first mobile electronics device 121, by a browser running on the first mobile electronics device 121 and accessing a web server over the internet 50, by a built-in function of the first mobile electronics device 121, or by any other method of presenting a GUI on the first mobile electronics device 121. The first GUI includes at least a first selectable element to provide information about a disaster event, and a second selectable element to provide information about a violence event. The first GUI may also include a third selectable element to dial a pre-defined emergency number in some embodiments. If the third selectable element were to be selected, a voice communication session would be initiated to the pre-defined emergency number using a wireless communication interface of the first mobile electronic device 121. The first individual, in this example, selects the second selectable element because they have noticed the intruder 105 and are concerned that a violence event may take place, or they have already heard shots or seen an act of violence.

The first mobile electronic device 121 detects the selection of the second selectable element of the GUI to determine a selected element, which in this example is the second selectable element. Alternatively, if the first individual had selected the first selectable element of the GUI, the first mobile electronic device 121 would have detected the selection of the first selectable element of the GUI to determine that that first element was the selected element. In response to the selection of the first selectable element, the first mobile device 121 presents a second GUI to allow the first individual to enter specific information about the emergency event that they are witnessing. The second GUI includes at least one pre-defined field for user input that is customized to the selected element, which in this case is a violence event. The pre-defined field could be any field specific to selected event type that is not included in at least one non-selected event type. In the example GUI 440 shown in FIG. 4E, a pre-defined field for user input that is customized to the selected event is the “Locked down room” field which allows the first individual to enter whether or not the room where they are located has been locked down in an attempt to keep the intruder out.

The first individual can enter various types of information into the second GUI, including, but not limited to, any combination of a location, their name or other identifying information about themselves, the number of intruders or perpetrators of violence, information about the intruders/perpetrators, the number of people with the first individual, the number of known injured people, whether or not the first individual feels they are safe, whether or not the room is locked down, a picture or video of the scene of the incident, an audio message, and other information about the incident. The information about the incident may be directly entered into the various fields of the GUI by the first individual, but in some embodiments, at least some of the information is automatically gathered by the first mobile electronics device 121. For example, depending on the embodiment, the location information may be manually entered by the first individual as a room number, a grid identifier, or other written description of the location. In some embodiments, however, the location information may be automatically determined by the first mobile electronic device 121 through detection of one or more radio-frequency beacons located in the vicinity of the first mobile electronic device 121. A beacon, as it is used herein and in the claims, may refer to any type of radio-frequency broadcast that identifies itself and has a known location. This may include transmitters intended to be used as a beacon, such as iBeacon transmitters from Apple, as well as WiFi access points, Bluetooth devices, or various other types of wireless transmitters. In some embodiments, the location information may be automatically determined by the first mobile electronics device 121 using a global positioning system (GPS) receiver. As used herein, including the claims, GPS refers to any system that uses signals from one or more satellites, launched by any country or company, to determine a position on or near the earth's surface.

As the information is entered into the second GUI, the information is collected by the first mobile electronics device 121, which sends the collected information to a server 150 over a network connection, such as the internet 50. In some embodiments, the information collected through the second GUI may be sent as it is entered into the second GUI. But in other embodiments, the user may be presented with a selectable element in the second GUI to initiate the sending of the collected information to the server 150. The network can be any type of network, including packet-switched networks or connection-based networks, and can be a heterogeneous set of interconnected networks, a homogenous proprietary network, or any other combination of one or more networks. One or more segments of the network may utilize wireless networks such as, but not limited to, any protocol published by IEEE 802.11 (Wi-Fi) including 802.11-1997 (sometimes called legacy 802.11), 802.11-2007, 802.11-2012, 802.11a, 802.11b, 802.11g, 802.11n, 802.11ac, 802.11ad, 802.11af, 802.11ah, 802.11ai, 802.11aj, 802.11aq, and 802.11ax, any version of IEEE-802.16 (WiMAX™), proprietary point-to-point microwave links, and any wireless telephony protocol including, but not limited to, GSM, Universal Mobile Telecommunications System (UMTS), High-Speed Downlink Packet Access (HSDPA), CDMA2000®, Evolution-Data Only (EVDO), Long-Term Evolution (LTE), and in the future, 5G protocols.

The server 150 receives the collected information from the first mobile electronic device 121. Meanwhile the second and third individuals may also notice that a violent incident is occurring and use the second mobile electronic device 122 and third mobile electronic device 123, respectively, to collect information about the violent incident and send their collected information to the server 150 as well. The server 150 stores the collected information from the first mobile electronic device 121 in a database with other information about the event received by the server 150 from other mobile electronic devices, such as the second mobile electronic device 122 and the third mobile electronic device 123, to create merged information. Depending on the embodiment, the database storage may be directly connected to the server 150, or may be located remotely from the server 150 and accessible through a local area network (LAN), through the internet 50, or through any other type of communication mechanism.

In some embodiments, the server 150 is provided with pre-defined rules to generate one or more commands based on the collected information received from one or more mobile electronic devices 121-123. If the information received by the server 150 conforms to one or more of the pre-defined rules, the server 150 sends a command to one or more controlled devices. The command can control the controlled device and the type of action controlled depends on the controlled device. In various embodiments, the one or more controlled devices may include, but are not limited to, a siren, a flashing light, a door lock, a gas shut-off valve, a fire suppression system, or an emergency lighting system. In some cases, at least one of the one or more controlled devices is located in proximity to the mobile electronic device that sent the collected information that caused the command to be sent, such as locking the door 111D of room 111 based on the collected information from the first mobile electronic device 121.

The server 150 can retrieve various portions of the merged information to send to one or more incident managers. In some embodiments, the server 150 uses pre-defined rules to determine at least a portion of the merged information to retrieve for a particular incident manager. In other embodiments, an incident manager may use an electronic device 170 to send a request for information about the event to the server 150. The server 150 receives the request for information about the event and can then use the request to determine the portion of the merged information to retrieve.

In some embodiments, the electronic device 170 sends a credential to the server 150 to authenticate the identity of the incident manager and/or the application running on the electronic device 170. The credential may include, but is not limited to, an account name with or without a password, an electronic certificate or other cryptographic data element, a device identifier such as a MAC address or electronic serial number, a biometric identifier such as data representing a fingerprint, an iris scan, an image of a face, or a voice sample, or any other type of electronic identifier. After receiving the credential, the server 150 validates the credential and determines a set of permissions associated with the credential. Access to at least some of merged information may then be restricted based on the set of permissions.

Once the portion of the merged information to retrieve has been identified, the server 150 can retrieve the portion of the merged information from the database to create retrieved information. The retrieved information is sent from the server 150 to the electronic device 170, based on either the pre-defined rules for determining the portion of the merged information to retrieve for the electronic device 170, or a request received from the electronic device 170. In some embodiments, some of the retrieved information may be removed before it is sent based on the credential received from the electronic device 170.

The retrieved information is received at the electronic device 170. The electronic device may be any type of electronic device or system with a display and a mechanism for interaction with a user. In some embodiments, the electronic device 170 is a tablet, but in other embodiments, the electronic device 170 may be a smartphone, a laptop computer, a desktop computer, an all-in-one computer, a wearable computer, a purpose-built electronic device, or any other type of electronic device. In some embodiments, a GUI is presented on a display of the electronic device 170 to allow the user to select how to display the retrieved information, although a default presentation may be used in other embodiments. In at least one embodiment, at least a first portion of the retrieved information is displayed in a first format on the electronic device 170 in response to a first user input, and at least a second portion of the retrieved information is displayed in a second format on the electronic device 170 in response to a second user input. In some embodiments, the first portion of the retrieved information and the second portion of the retrieved information have at least one piece of information in common, such as the status of the reporter, for example, although the common information may be displayed differently in the two formats, such as using an icon in one format and textual information in another format.

In some embodiments, the retrieved information includes location information. At least one embodiment uses a tabular presentation of the retrieved information for the first format and a cartographic presentation of the retrieved information, based at least in part on the location information, for the second format. A cartographic presentation can be any type of presentation of any portion of the retrieved information that shows a spatial relationship between various elements of the retrieved information and the real-world environment. In some embodiments, the cartographic presentation may use icons for each reporter overlaid on a floorplan of the building or a three-dimensional transparent view of the building. In another embodiment, the cartographic presentation may include a map of a campus or city, and images representing various emergency incidents may then be placed on the map. In another embodiment, the electronic device 170 may include a virtual reality display, and the cartographic presentation may place images received from various mobile electronic devices at appropriate locations within the virtual environment representing a portion of the real world. In yet another embodiment, the electronic device 170 may include a head-mounted augmented reality display, and the cartographic presentation may include virtual elements representing information reports received from various mobile electronic devices at appropriate locations within the view of the incident manager wearing the augmented reality display.

The location information may be received in various formats for different reports received (e.g. the collected information), such as textual description, a grid locator, beacon information, and GPS coordinates. So for example, the retrieved information may include a first set of data associated with a first location identified by user-entered data from the first mobile electronic device 121, a second set of data associated with a second location identified by a beacon identifier determined by the second mobile electronics device 122, and a third set of data associated with a location identified by GPS coordinates generated from GPS signals received by the third mobile electronics device 123. The various types of location information are translated to positions in the cartographic presentation by either the server 150 or the electronic device 170. So in the example identified, the user entered data is translated to a first position of the cartographic presentation and a representation of at least a portion of the first set of data is displayed at the first position of the cartographic presentation on the electronic device 170. The beacon identifier is translated to a second position of the cartographic presentation and a representation of at least a portion of the second set of data is displayed at the second position of the cartographic presentation on the electronic device 170. And the GPS coordinates are translated to a third position of the cartographic presentation and a representation of at least a portion of the third set of data is displayed at the third position of the cartographic presentation on the electronic device 170.

In some embodiments, a GUI having a selectable confirmation element associated with a set of collected information from the first mobile electronic device 121 is displayed on the electronic device 170, and a selection of the confirmation element is detected. In response to detecting the selection of the confirmation element, a confirmation message is sent from the electronic device 170 to the first mobile electronic device 121, which receives the confirmation message and presents an indication that the confirmation message was received. The presentation of the indication may be done visually, such as through textual message, a color, or an icon, on a GUI on the first mobile electronic device 121, or audibly, such as through a voice message or a tone or beep.

In some embodiments, a status message regarding the event is broadcast from the electronic device 170. Broadcast, as used herein, means to send a message to more than one device, e.g. to multiple mobile electronic devices 121-123. The status message is then received at the first mobile electronic device 121 and at least one of the other mobile electronic devices 122, 123. The status message is then presented at the first mobile electronic device 121. The presentation of the status message may be done visually, such as through a GUI on the first mobile electronic device 121, or audibly.

In some embodiments, an input is received at the electronic device 170 and a command sent from the electronic device 170 to one or more controlled devices based on the input. The input may be a user input to a human input device on the electronic device 170, or the input may be a set of data received as a part of the retrieved data from the server 150 and processed according to rules stored on the electronic device 170. The command can control the controlled device and the type of action controlled depends on the controlled device. In various embodiments, the one or more controlled devices may include, but are not limited to, a siren, a flashing light, a door lock, a gas shut-off valve, a fire suppression system, or an emergency lighting system. In some cases, at least one of the one or more controlled devices is located in proximity to one of the mobile electronic devices, such as locking the door 113D of room 113 based on the collected information from the first mobile electronic device 123.

In an alternate example, the third individual in room 113 may smell smoke and select the first selectable element on the GUI of the third mobile electronic device 123 to provide information about a disaster event. In response to the detection of the selection of the first selectable element, the third mobile electronic device 123 presents a GUI, such as that shown in FIG. 4B, that includes a plurality of selectable elements that respectively represent types of disasters. The types of disasters included in the GUI may be vary according to the embodiment, but may include any combination of an earthquake, a fire, a fire alarm sounding, a flood, a tornado, a hurricane, a tsunami, a weather event, a gas leak, a downed electrical wire, a chemical spill, an environmental hazard, or any other type of emergency incident. A selection of one of the plurality of selectable elements of the third GUI is detected by the third mobile electronic device 123 to determine a selected type of disaster. At least one pre-defined field is determined for a GUI on the third mobile electronic device 123 based on the selected type of disaster, and information about the disaster is collected by the third mobile electronic device 123 and sent to the server 150 where it is handled similarly to the first example.

The system 100 is an example of a system suitable for various embodiments, but one of ordinary skill will understand that many other system configurations would also be suitable and may substitute different types of electronic devices for the devices shown, or may include additional devices. For example, a distributed cluster of servers could replace the server 150, additional smart watches, smart phones, and tablets used by reporting users may be included, or additional wearable computers, tablets, and laptops used by incident managers and emergency responders may be included. In some embodiments, a thin client may be used by one or both of a reporting party and an incident manager, with the program running on a server, which may be the server 150 or may be another server in the system 100. Different modes of communication networks may also be used in some embodiments, such as mesh networks, peer-to-peer communication, or other communication topologies. Some systems may also include devices to convert one type of communication to another, such as to convert short message system (SMS) text messages to status reports to send to the server 150. In addition, many types of peripheral devices may also be included in the system 100, such as printers, fax machines scanners, external storage devices, portable storage devices, additional displays, routers, gateways, or other types of computer peripherals.

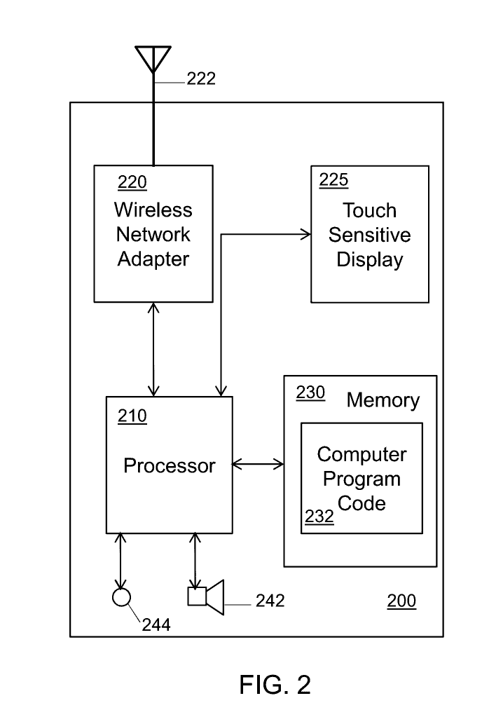

FIG. 2 shows a block diagram of a mobile electronic device 200 suitable for various embodiments. The mobile electronic device 200 may be a smartphone in some embodiments, but in other embodiments, the mobile electronic device 200 may be a tablet, a personal digital assistant (PDA), a laptop, or any other electronic device capable of being programmed to execute instructions or programs.

The mobile electronic device 200 includes a processor 210 coupled to a wireless network adapter 220 with antenna 222. In some embodiments, the wireless network adapter 220 may support a single protocol on a single frequency, but in other embodiments, the wireless network adapter 220 may support multiple protocols on multiple frequency bands and include multiple radio transceivers, transmitters, or receivers. The wireless network adapter 220 can transmit and receive messages. In various embodiments, the wireless network adapter 220 may support any type of radio frequency (RF) protocol at any wavelength or frequency, including, but not limited to, any protocol published by IEEE 802.11 (Wi-Fi) including 802.11-1997 (sometimes called legacy 802.11), 802.11-2007, 802.11-2012, 802.11a, 802.11b, 802.11g, 802.11n, 802.11ac, 802.11ad, 802.11af, 802.11ah, 802.11ai, 802.11aj, 802.11aq, and 802.11ax, any version of IEEE-802.16 (WiMAX), and any wireless telephony protocol including, but not limited to, GSM, Universal Mobile Telecommunications System (UMTS), High-Speed Downlink Packet Access (HSDPA), CDMA2000®, Evolution-Data Only (EVDO), LTE, and in the future, 5G protocols.

The example mobile electronic device 200 also includes a touch-sensitive display 225 coupled to the processor 210. The touch sensitive display 225 can be have any spatial resolution and support any number of colors, but in embodiments, the display has a resolution of at least 320×240 and supports at least 16 colors. Some embodiments may have a resolution of 1920×1080 or higher and support 16 million or more colors. Any technology may be used for the display, including, but not limited to, liquid crystal display (LCD) and active-matrix organic light-emitting diode (AMOLED) display technology. The touch-sensitive display 225 detects one or more touch points on the surface of the display as a human-input device for the mobile electronic device 200.

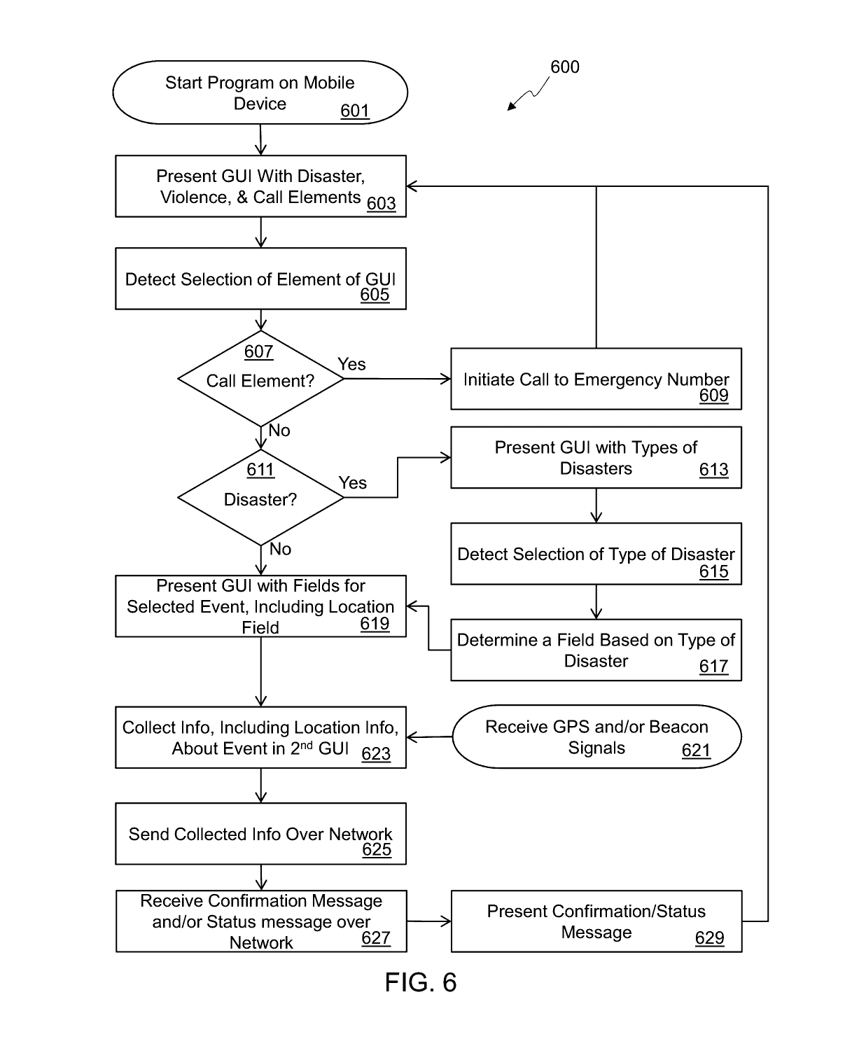

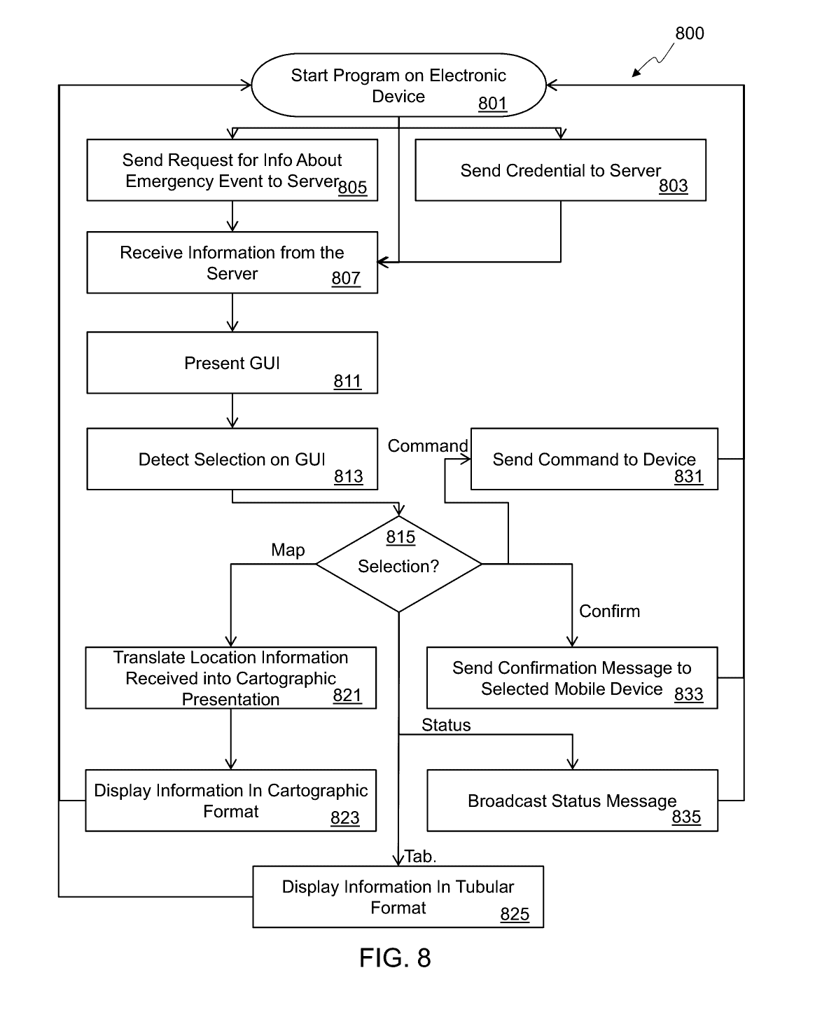

The processor 210 is also coupled to memory 230. The memory 230 includes one or more computer readable media, such as volatile semiconductor memory devices, non-volatile semiconductor memory devices, optical disks, rotating magnetic media, or any other type of non-transitory, volatile or non-volatile, computer readable storage. The memory 230 can be used to store various data, depending on the embodiment. In at least one embodiment, the memory 230 stores at least one computer program 232 with code to report information related to an emergency incident. The functionality of example computer programs 232 that could be stored in memory 230 and executed by the processor 210 are shown in the flowcharts of FIG. 6 and FIG. 8.

In many embodiments, one or more speakers 242 and a microphone 244 are also coupled to the processor 210. The microphone 244 and speaker 242 may be used for voice communication between a reporting party and an incident manager, emergency responder, or emergency dispatcher (e.g. a 911 operator). The microphone 244 may also be used as an input device for providing status information either by a recorded audio message or by using a speech recognition system to translate the speech into text. The speaker 242 may be used to present status or confirmation messages to the user, such as beeps, sirens, and voice messages.

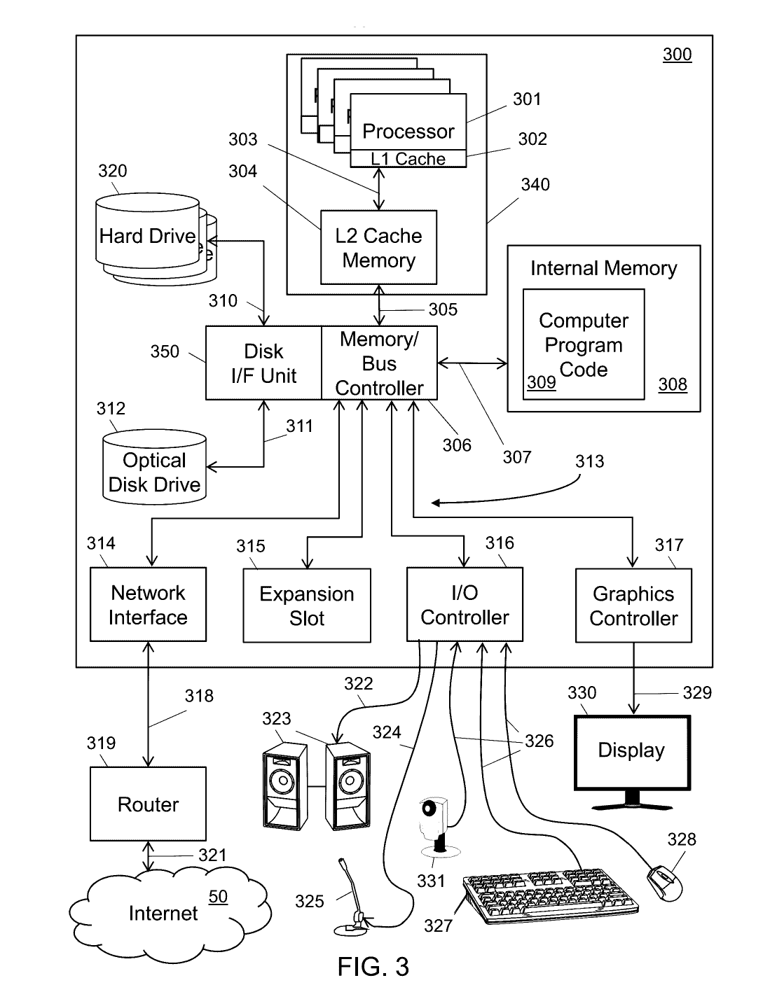

FIG. 3 shows a block diagram of an electronic device suitable for use as a server 150 or electronic device 170 to run the incident manager application of various embodiments. In some cases a mobile electronics device suitable to run the reporter application may also conform to the block diagram of the computer system 300. The computer system 300 may be configured in the form of a desktop computer, a laptop computer, a rack-mounted server, a tower server, a blade server, a mainframe computer, or any other hardware or logic arrangement capable of being programmed or configured to carry out instructions. In some embodiments the computer system 300 may act as a server, accepting inputs from remote users over a local area network (LAN) 318 or the internet 50. In other embodiments, the computer system 300 may function as an electronic device used by an administrator for managing the emergency event and may take the shape of a desktop computer, a laptop computer, a tablet, or some other type of electronic device. The computer system 300 may be located and interconnected in one location. Alternatively, it may be distributed in various locations and interconnected via communication links such as a LAN 318 or a wide area network (WAN), via the Internet 50, via the public switched telephone network (PSTN), a switching network, a cellular telephone network, a wireless link, or other such communication links. One skilled in the art may recognize that many different architectures may be suitable for the computer system 300, but only one typical architecture is depicted in FIG. 3.

The computer system 300 may include a processor 301 which may be embodied as a microprocessor, two or more parallel processors, a central processing unit (CPU), or other such control logic or circuitry. The processor 301 may be configured to access a local cache memory 302, and send requests for data that are not found in the local cache memory 302 across a cache bus 303 to a second level cache memory 304. Some embodiments may integrate the processor 301 and the local cache 302 onto a single integrated circuit, and other embodiments may utilize a single level cache memory or no cache memory at all. Other embodiments may integrate multiple processors 301 onto a single die and/or into a single package. Yet other embodiments may integrate multiple processors 301 having multiple local cache memories 302 with a second level cache memory 304 into a single package 340 having a front side bus 305 to communicate to a memory/bus controller 306. The memory/bus controller 306 may accept accesses from the processor(s) 301 and direct them to either the internal memory 308 over memory bus 307 or to the various input/output (I/O) busses 310, 311, 313. A disk interface unit 350 may connect through the communication link 310 to the hard disk drive 320 and/or other communication link 311 to the optical disks 312 and may be integrated into the memory/bus controller 306 or may be a separate chip. Some embodiments of the computer system 300 may include multiple processor packages 340 sharing the front-side bus 305 to the memory/bus controller 306. Other embodiments may have multiple processor packages 340 with independent front-side bus connections to the memory/bus controller 306. The memory bus controller 306 may communicate with the internal memory 308 using a memory bus 307. The internal memory 308 may include one or more of random access memory (RAM) devices such as synchronous dynamic random access memories (SDRAM), double data rate (DDR) memories, or other volatile random access memories. The internal memory 308 may also include non-volatile memories such as electrically erasable/programmable read-only memory (EEPROM), NAND flash memory, NOR flash memory, programmable read-only memory (PROM), read-only memory (ROM), battery backed-up RAM, or other non-volatile memories. The various memory devices are embodiments of a non-transitory computer readable storage medium suitable for storing computer program code, i.e. instructions, and/or data. The internal memory 308 may store computer program code 309 that is executable by the processor 301 to perform one or more methods described herein, or other tasks as may be appropriate for the system 300. In some embodiments, the computer system 300 may also include 3rd level cache memory or a combination of these or other like types of circuitry configured to store information in a retrievable format. In some implementations the internal memory 308 may be configured as part of the processor 301 or, alternatively, may be configured separate from it but within the same package 340. The processor 301 may be able to access internal memory 308 via a different bus or control lines than are used to access the other components of computer system 300.

The computer system 300 may also include, or have access to, one or more hard disk drives 320 (or other types of non-volatile storage memory) and optical disk drives 312. Hard disk drives 320 and the optical disks for optical disk drives 312 are examples of non-transitory machine readable (also called computer readable) media suitable for storing computer program code and/or data. The optical disk drives 312 may include a combination of several disc drives of various formats that can read and/or write to removable storage media (e.g., CD-R, CD-RW, DVD, DVD-R, DVD-W, DVD-RW, HD-DVD, Blu-Ray, and the like). Other forms or computer readable media that may be included in some embodiments of computer system 300 include, but are not limited to, floppy disk drives, 9-track tape drives, tape cartridge drives, solid-state drives, cassette tape recorders, paper tape readers, bubble memory devices, magnetic strip readers, punch card readers, or any other type or computer useable storage medium. The computer system 300 may either include the hard disk drives 320 and optical disk drives 312 as an integral part of the computer system 300 (e.g., within the same cabinet or enclosure and/or using the same power supply), as connected peripherals, or may access the hard disk drives 320 and optical disk drives 312 over a network, or a combination of these. The hard disk drive 320 can contain any number of non-volatile storage units that can each be a traditional rotating magnetic media hard drive, a solid state storage drive (SSD) using semiconductor memories, or some other type of storage device, configured for the storage and retrieval of data, computer programs or other information. The hard disk drive 320 need not necessarily be contained within the computer system 300. For example, in some embodiments the hard disk drive 320 may be server storage space within a network that is accessible to the computer system 300 for the storage and retrieval of data, computer programs, or other information. In some instances the computer system 300 may use storage space at a server storage farm or similar type of storage facility that is accessible by the Internet 50 or other communications lines, and may be referred to as “cloud storage.” The hard disk drive 320 is often used to store the software, instructions, and programs executed by the computer system 300, including for example, all or parts of the computer application program for carrying out activities of the various embodiments. The computer program code 309 may be stored on the hard disk drive 320 and copied into internal memory 308 for execution by the processor 301 in some embodiments. Examples of the functionality of computer program code 30 that may be executed by the processor 301 are shown in the flowcharts of FIG. 6-8.

The disk interface 310 and/or communication link 311 may be used to access the contents of the hard disk drives 320 and optical disk drives 312. These interfaces/links 310, 311 may be point-to-point links such as Serial Advanced Technology Attachment (SATA) or a bus type connection such as Parallel Advanced Technology Attachment (PATA) or Small Computer System Interface (SCSI), a daisy chained topology such as IEEE-1394, a link supporting various topologies such as Fibre Channel, or any other computer communication protocol, standard or proprietary, that may be used for communication to computer readable medium.

The memory/bus controller may also provide other I/O communication links 313. In some embodiments, the links 313 may be a shared bus architecture such as peripheral component interface (PCI), microchannel, industry standard architecture (ISA) bus, extended industry standard architecture (EISA) bus, VERSAmodule Eurocard (VME) bus, or any other shared computer bus. In other embodiments, the links 313 may be a point-to-point link such as PCI-Express, HyperTransport, or any other point-to-point I/O link. Various I/O devices may be configured as a part of the computer system 300. In many embodiments, a network interface 314 may be included to allow the computer system 300 to connect to a network 318. The network 318 may be an IEEE 802.3 ethernet network, an IEEE 802.11 Wi-Fi wireless network, or any other type of computer network including, but not limited to, LANs, WAN, personal area networks (PAN), wired networks, radio frequency networks, powerline networks, and optical networks. A router 319 or network gateway, which may be a separate component from the computer system 300 or may be included as an integral part of the computer system 300, may be connected to the network 318 to allow the computer system 300 to communicate with the internet 50 over an internet connection 321 such as an asymmetric digital subscriber line (ADSL), data over cable service interface specification (DOCSIS) link, T1 or other internet connection mechanism. In other embodiments, the computer system 300 may have a direct connection to the internet 50. In some embodiments, an expansion slot 315 may be included to allow a user to add additional functionality to the computer system 300.

The computer system 300 may include an I/O controller 316 providing access to external communication interfaces such as universal serial bus (USB) connections 326, serial ports such as RS-232, parallel ports, audio in 324 and audio out 322 connections, the high performance serial bus IEEE-1394 and/or other communication links. These connections may also have separate circuitry in some embodiments or may be connected through a bridge to another computer communication link provided by the I/O controller 316. A graphics controller 317 may also be provided to allow applications running on the processor 301 to display information to a user. The graphics controller 317 may output video through a video port 329 that may utilize a standard or proprietary format such as an analog video graphic array (VGA) connection, a digital video interface (DVI), a digital high definition multimedia interface (HDMI) connection, a DisplayPort (DP) connection, or any other video interface. The video connection 329 may connect to a display 330 to present the video information to the user. The display 330 may be any of several types of displays, including a liquid crystal display (LCD), a cathode ray tube (CRT) monitor, an organic light emitting diode (OLED) array, or any other type of display suitable for displaying information for the user. The display 330 may be a head-mounted augmented reality display, a virtual-reality display, or other immersive display. The display 330 may include one or more light emitting diode (LED) indicator lights, or other such display devices. Typically, the computer system 300 includes one or more user input/output (I/O) devices such as a keyboard 327, mouse 328, and/or other means of controlling the cursor represented including but not limited to a touchscreen (which may be integrated with the display 330), touchpad, joystick, trackball, tablet, or other device. The user I/O devices may connect to the computer system 300 using USB 326 interfaces or other connections such as RS-232, PS/2 connector or other interfaces. Some embodiments may include a webcam 331 which may connect using USB 326, a microphone 325 connected to an audio input connection 324, and/or speakers 323 connected to an audio output connection 322. The keyboard 327 and mouse 328, speakers 323, microphone 325, webcam 331, and monitor 330 may be used in various combinations, or separately, as means for presenting information to the user and/or receiving information and other inputs from a user to be used in carrying out various programs and calculations. Speech recognition software may be used in conjunction with the microphone 325 to receive and interpret user speech commands.

FIG. 4A-4H show example graphical user interface (GUI) screens of an embodiment of the reporter application on a mobile electronic device. The GUI screens may also be generated by a web site on a server and presented by a browser running on the mobile electronic device in some embodiments.

FIG. 4A shows an embodiment of a GUI 400 that allows a reporting user to select the type of incident that they are reporting on. The GUI 400 includes selectable elements 401-404, 491-492, that may be selected using a touchscreen interface, a mouse, a joystick, or some other type of human input device. The GUI 400 includes a first selectable element 401 to indicate that the report will be about a disaster and a second selectable element 402 to indicate that the report will be about a violent incident, in this case an act of workplace violence. In other embodiments, the second selectable element 402 may indicate a report for school violence or simply an act of violence. In at least some embodiments, selection of the first selectable element 401 causes the GUI 410 shown in FIG. 4B to be displayed to allow the reporting user to select which type of disaster event is being reported, but in other embodiments, a GUI similar to the GUI 420 shown in FIG. 4C may be launched to allow the user to directly enter information about the disaster. If the second element 402 is selected, a GUI that allows the user to select a type of violent event may be shown in some embodiments, but in other embodiments, the GUI 440 shown in FIG. 4E is presented to allow the user to enter information about the violent event.

In some embodiments, the GUI 400 may include a third selectable element 403 to allow an emergency number to be automatically dialed and a voice communication session (e.g. a voice phone call) initiated to the emergency number. A GUI 450 as shown in FIG. 4F may be launched in response to selection of the third selectable element 403. The emergency number may be the universal emergency number, 911, or may be set to a different phone number for the organization providing the system, such as the security department of a company, depending on the embodiment. Various other selectable elements, such as the fourth selectable element 404 may be included in some embodiments for additional types of emergencies or a catch-all of other emergencies as shown. If included, these additional selectable elements may launch a GUI to allow collection of information about that particular type of emergency or may present a generic GUI to collect general information about an emergency incident, depending on the embodiment.

In some embodiments, the name or other identifier of the reporting user may be pre-entered into the application. This may be done with a login and password to the application or may simply be a fillable field showing the person's identity. The identity of the reporting individual, “Dave Johnson” in this example, may be shown on the GUI 400 along with location information 499 in some cases. The location information may be automatically generated, in some embodiments, by the device presenting the GUI 400 using beacons, GPS, or some other location identification technology. In other embodiments, the location information may be manually entered into the application. In some embodiments, a set-up screen may be launched if the set-up icon 491 is selected, and selecting the Instruction icon 492 may cause one or more instructional screens, such as the GUI 460 of FIG. 4G and the GUI 470 of FIG. 4H to be shown.

FIG. 4B shows an embodiment of a GUI 410 that allows a reporting user to select a particular type of disaster that they are reporting on. The GUI 410 may include any number of selectable elements 411-416 to present the user with an array of options. In the example show, the user can choose from an earthquake selection 411, a fire selection 412, a tornado selection 413, a fire alarm selection 414, a gas/electrical hazard selection 415, and a general weather selection 416. Other embodiments may include different types of disasters, such as hurricane, flood, sinkhole, hail storm, chemical spill, downed power lines, or any other type of disaster. Some embodiments may include a scroll bar to allow the user to see additional types of disasters, and some embodiments may have an “other” category for the user to select. Once the reporting user has selected a particular type of disaster, at least one pre-defined field customized for that disaster may be determined and used in another GUI, such as the GUI 420 shown in FIG. 4C.

FIG. 4C shows an embodiment of a GUI 420 that allows the reporting user to enter information about the type of disaster that was selected in the GUI 410, in this example, an earthquake. The GUI 420 may include any number of pre-defined fields, but includes at least one field that is specific to the type of disaster selected, such as the field “Collapsed?” 422 that allows a reporting user to report whether or not the building they are in has collapsed. Other pre-defined fields may be specific to one or more types of disasters, such as “Wires Down?” 423, “Any People Trapped?” 424, and “Do you Smell Gas?” 426. Other pre-defined fields may be generic to all disasters such as “Injured” 425 and “I Am Safe” 427. Some embodiments may include a generic field to allow a user to enter information that may not be covered by a pre-defined field. Any number of pre-defined fields may be provided in the GUI 420 and in some embodiments, a scroll bar may be provided to allow access to more fields than can be easily viewed at one time on the display.

In some embodiments, the GUI 420 includes one or more other icons to allow the user to navigate to other screens from the GUI 420. The Home icon 493 may return the user to the GUI 400 shown in FIG. 4A to allow the user to start over again. The Instructions icon 492 may direct the user to one or more instructional screens, such as the GUI 460 of FIG. 4G and the GUI 470 of FIG. 4H. A Phone icon 494 may automatically dial the emergency number, acting the same as the third selectable element 403 on the GUI 400. A Chat icon 495 may bring up a chat window to allow for real-time two-way interaction with the incident manager. Other icons may be included in other embodiments for various other purposes.

FIG. 4D shows an embodiment of a GUI 430 that allows a reporting user to see the information 435 that they have previously provided. The GUI 430 may provide selectable elements for the user in the GUI 430, such as a first element 431 to allow the user to submit a new report, a second element 432 to allow the user to amend the report shown, and a third element 433 to allow the user to indicate that they consider the incident closed. Other embodiments may provide additional selectable elements for the user to take other action regarding their report, such as to cancel the report, indicate that the report is still relevant at a later time, or other such action. In some embodiments, additional icons, such as the Home icon 493, the Instructions icon 492, the Phone icon 494, or the Chat icon 495 may also be available in the GUI 430.

FIG. 4E shows an embodiment of a GUI 440 that allows the reporting user to provide information about a workplace violence event. The GUI 440 may be displayed in response to the user selecting the second selectable element 402 on the GUI 400 to indicate that a violent event is taking place. The GUI 440 may include any number of pre-defined fields, with at least one field that is specific to a violent incident, such as the field “Locked down room” 445 that allows a reporting user to report whether or not the room they are in has been locked. Other pre-defined fields may be specific or generic, such as “Location” 442, “I Am Safe” 444, “Injured” 446, and “People with me” 447. Some embodiments may include a generic field 443 to allow a user to enter information that may not be covered by a pre-defined field. Any number of pre-defined fields may be provided in the GUI 440, and in some embodiments, a scroll bar may be provided to allow access to more fields than can be easily viewed at one time on the display.

In some embodiments, the GUI 440 includes one or more other icons to allow the user to navigate to other screens from the GUI 440. The Home icon 493 may return the user to the GUI 400 shown in FIG. 4A to allow the user to start over again. The Instructions icon 492 may direct the user to an instructional screen, such as the GUI 460 of FIG. 4G or the GUI 470 of FIG. 4H. A Phone icon 494 may automatically dial the emergency number, acting the same as the third selectable element 403 on the GUI 400. A Chat icon 495 may bring up a chat window to allow for real-time two-way interaction with the incident manager. Other icons may be included in other embodiments for various other purposes.

FIG. 4F shows an embodiment of a GUI 450 that automatically dials an emergency number, such as ‘911’. The emergency number may be pre-set to any appropriate telephone number, depending on the embodiment. The number to be dialed may be shown in a display area 451 and in some embodiments, the user may be asked to hit a dial button 452 to verify that they really want to dial the emergency number. In some embodiments, the user may be able to use the keypad 453 to enter another number to dial instead of the emergency number.

FIG. 4G shows an embodiment of a GUI 460 that provides instructions 461 for how to respond to an earthquake and FIG. 4H shows an embodiment of a GUI 470 that provides instructions 471 for how to respond in case of a fire. Other types of incidents may also have instructions included which may be selected by using different tabs in the GUIs 460, 470, or by swiping between screens. The Home icon 493 may be provided to allow the user to navigate back to the GUI 400 along with other navigational icons in some embodiments.

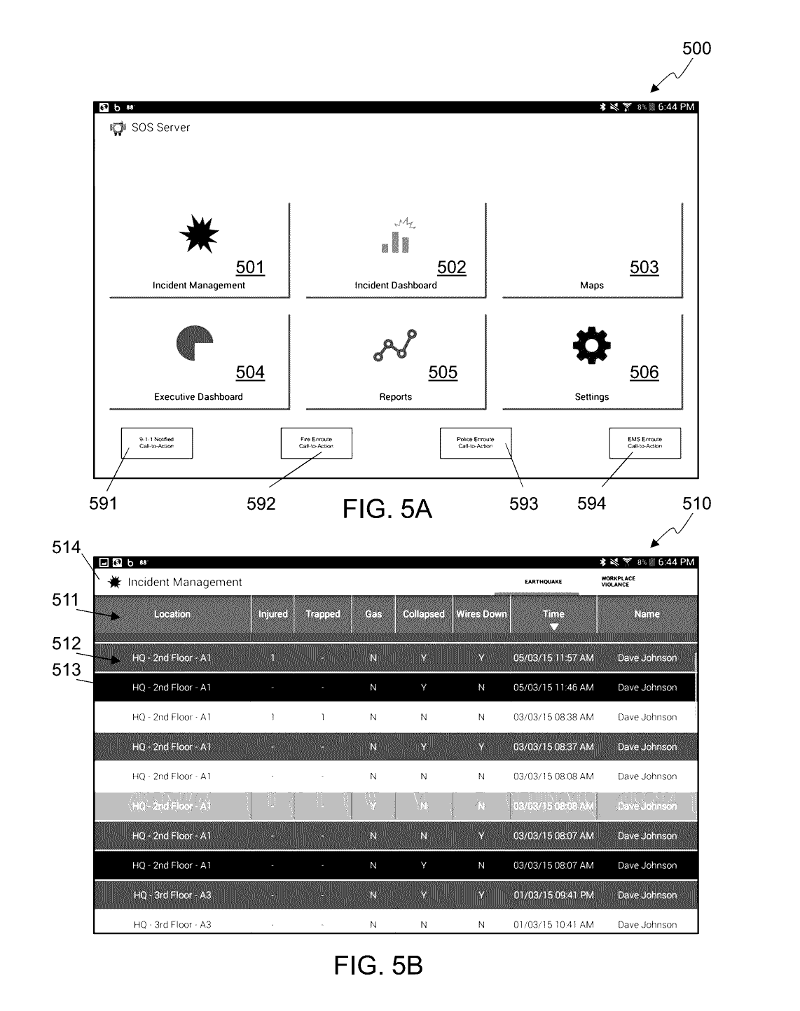

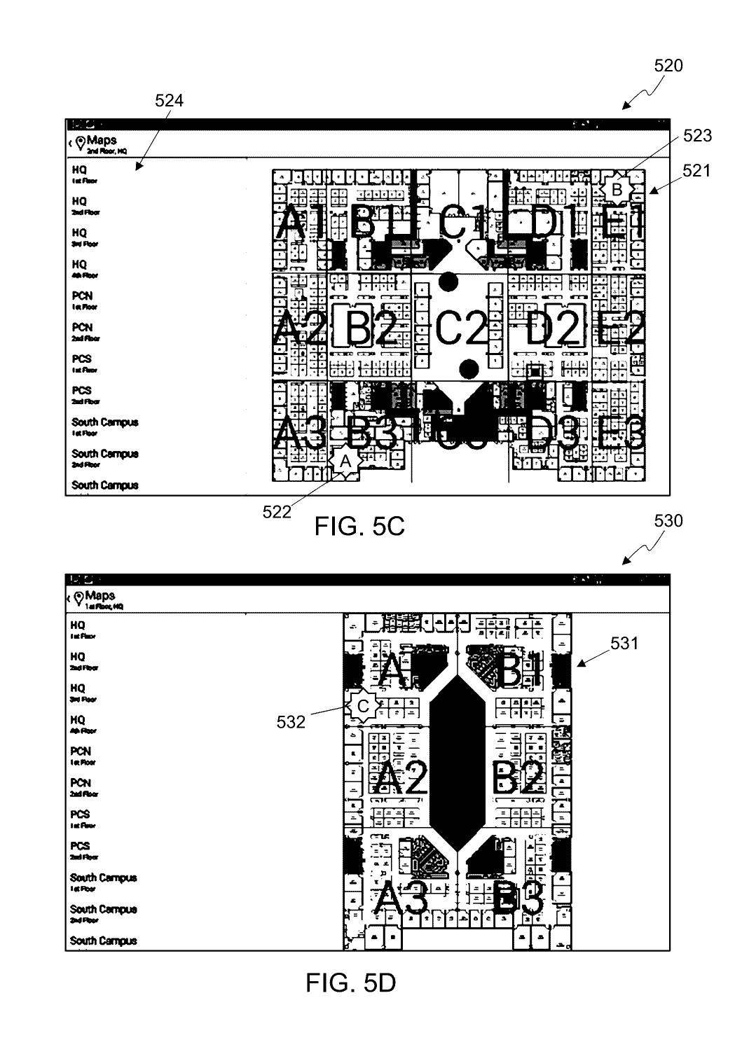

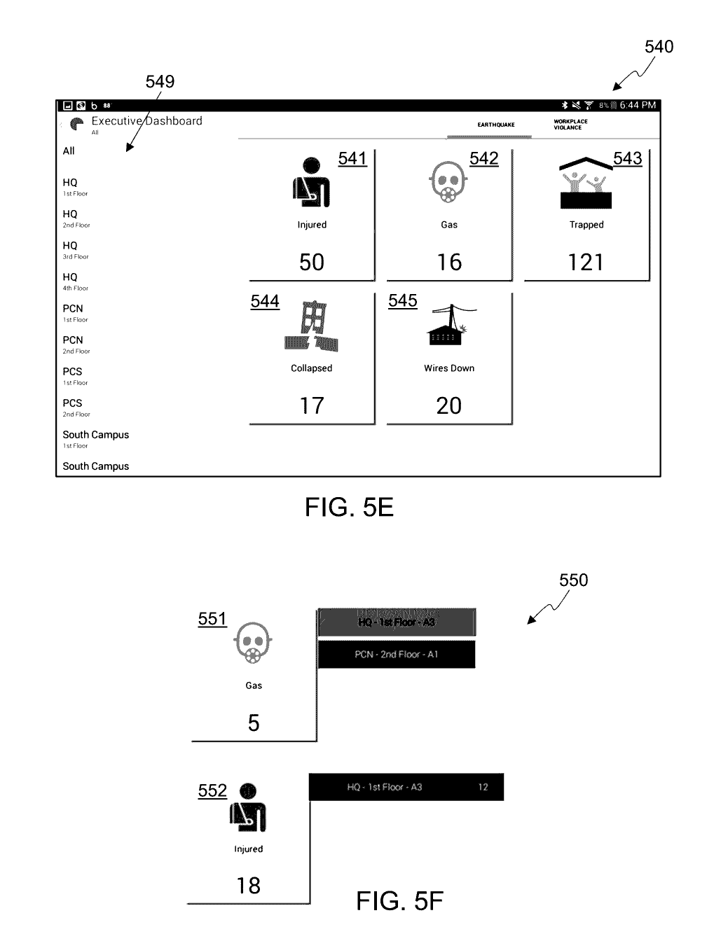

FIG. 5A-5F show example graphical user interface (GUI) screens of an embodiment of the incident manager application on an electronic device. The GUI screens may also be generated by a web site on a server and presented by a browser running on the electronic device in some embodiments.

FIG. 5A shows an embodiment of a GUI 500 that provides an incident manager with a set of selectable elements useable to manage, organize, and view, data from multiple reporters. The GUI 500 may include any number of selectable elements, but in the example shown, an Incident Management element 501 allows the user to view information received from reporting users in a tabular format as shown in the GUI 510 of FIG. 5B. The Incident Dashboard element 502 allows detailed summary information about an emergency incident to be shown as in the GUI 560 of FIG. 5F. The Maps element 503 allows the user to view information received from reporting user in a cartographic format as shown in GUI 520 of FIG. 5C or GUI 530 of FIG. 5D. The Executive Dashboard element 504 allows for an overall summary of the reports received from reporting users about an incident to be viewed as shown in GUI 540 of FIG. 5E. Additional selectable elements may also be included, such as the Reports element 505 to allow a variety of pre-formatted reports to be generated, sent, or printed, and a Settings element 506 to allow various settings of the application to be viewed or changed.

Additional “call to action” elements 591-594 may also be included to allow the incident manager user to set the status of various items and, in some cases, to send out status information to appropriate reporting users. In the example shown, a call-to-action element 591 for 911 status is provided to indicate that 911 has been called. The color of the element 591 may change color to indicate the current status of the call, such as being red before 911 has been called and changing to green once the incident manager selects the element 591 to indicate that 911 has been called. Similarly, the call-to-action element 592 for the Fire Department, the call-to-action element 593 for the Police Department, and the call-to-action element 594 for the emergency medical services (EMS) may be selected to indicate whether or not the various emergency responders are on their way. The incident manager may change the status of the call-to-action elements 591-594 by selecting them, which may change their color and, in some cases, send a status message. The call-to-action status changes may be stored in a database or external storage to allow the call-to-action selections to be used for future reporting, analysis, or evidence.

FIG. 5B shows an embodiment of a GUI 510 that shows received incident reports in a tabular format. The tabular format includes a header row 511 that describes the information included in each column. Each row after that, such as the first row 512 and the second row 513, provide the information from one report. In the example shown, which is for an earthquake emergency, the first column includes location information. In this example, the location information, which may be received in various formats such as a room number or name, beacon information, and GPS coordinates, has been translated into a common format showing building name, floor number, and a grid identifier for that floor. The second column provides the number of injured people reported in that report. The third column provides the number of people trapped. The fourth column indicates whether gas could be smelled which could indicate a gas leak. The fifth column indicates if the building near the reporter had collapsed and the sixth column indicates whether the reporter has observed any downed electrical wires. The seventh column provides the time of the report and the eighth column provides the name of the reporting party. Other embodiments may not include all of the columns shown and some may include other columns of information. The GUI 510 may allow for the order of the columns to be rearranged, and the reports can be sorted in this embodiment by clicking on the column header to indicate the column to use for sorting. Some embodiments may also include a filtering function which may be engaged by any method, but in some embodiments, filtering may be done by holding a finger on the column header on the touchscreen until a filtering UI appears which allows filtering data to be entered for that column. In some embodiments, a set of permissions associated with a credential of the user may be used to restrict access to some of the information in the reports, such only showing the columns for gas smelled and location to a worker from the gas company. A return arrow 514 may be selected to return to the home GUI 510.

FIG. 5C shows an embodiment of a GUI 520 that provides a cartographic view, presentation, or format, of a portion of the data received in the reports. The GUI 520 may include a menu 524 of available maps for the organization, which may be limited to maps of locations that are involved in the emergency incident in some embodiments. A map may be selected from the menu 524, such as the map 521 of the second floor of the HQ building. In the example shown, there are two reports about the emergency incident that were made from the second floor of the HQ building, a first report A 522 was made from grid location B3 on the second floor, and a second report B 523 was made from grid location E1 on the second floor. Icons are then shown at the appropriate place on the floorplan for the first report A 522 and the second report B 523.

FIG. 5D shows an embodiment of a GUI 530 that also provides a cartographic view, presentation, or format, of a portion of the data received in the reports. The GUI 530 may have been selected from the menu 524 of GUI 520 by selecting the first floor map 531 of the HQ building. In the example shown, there is one report about the emergency incident that was made from the first floor of the HQ building, report C 532 which was made from grid location A1 on the first floor, and an icon is placed on the floorplan to show report C 532.

At least a portion of the information from the reports selected and associated with the selected map is shown in the cartographic format when selected. The information can include the location of the report shown by the placement of an icon on the map, the number of people covered by the report by the size of the icon, whether or not the people are safe by the color of the icon, and other information by the shape of the icon, hatch patterns on the icon, text, or other mechanisms to present data, which can vary according to the embodiment.

FIG. 5E shows an embodiment of a GUI 540 that provides an executive dashboard summarizing the reports received for an emergency incident. The GUI 540 may include a menu 549 to allow an incident manager to select one or more locations to summarize. In the example shown, all locations have been selected. The GUI 540 includes an Injured status 541 that shows the total number of injured people reported for the selected location(s), a Gas status 542 showing the total number of reports indicating that gas can be smelled in the selected locations, and a Trapped status 543 that shows the total number of trapped people reported for the selected location(s). The Collapsed status 517 provides the number of reports indicating that some portion of a building has collapsed, and a Wires Down status 545 shows the total number of reports indicating that electrical wires are down in the selected locations. Other embodiments may include any type of summary based on the information in the reports, and settings may be provided to control which status indicators are shown. In some embodiments, a set of permissions associated with a credential of the user may be used to restrict access to some of the information in the reports, such as only showing the number of reports of gas to a worker from the gas company.

FIG. 5F shows an embodiment of a GUI 550 that provides incident information. In the example shown, a status 551 shows that there have been 5 reports of smelling gas and that they have originated in two locations, shown in the flags attached to the status 551. Another status 552 shows that there have been reports of 18 people injured and the location of that report. Various GUIs such as the GUI 550 may be used to receive, store, sort, and display such an incident dashboard as the GUI 550 which shows reports by individual location, the status reports being sent by one or more users, or other criteria, for an emergency incident.

FIG. 6 is a flowchart 600 of an embodiment of the reporter application. The reporter application can be stored on a non-transitory computer-readable medium. The instructions of the reporter application, when executed by a processor, cause the processor to perform the operations shown in the flowchart 600. The reporter application may be executed by a processor of a mobile electronics device, such as the mobile electronics device 200 shown in FIG. 2.

The flowchart 600 begins at block 601 where the reporter program starts on the mobile electronics device and continues with presenting a first graphical user interface (GUI) 603 on a display coupled to the processor. The first GUI includes at least a first selectable element to provide information about a disaster event and a second selectable element to provide information about a violence event. In some embodiments, the first GUI includes a third selectable element to dial a pre-defined emergency number. The flowchart 600 continues by detecting a selection of the first selectable element or the second selectable element of the GUI 605 to determine a selected element.

The selected element is checked 607 to determine if the third selected element was selected. If it was, the flowchart 600 continues by initiating a voice communication session to the pre-defined emergency number 609 using a wireless communication interface coupled to the processor. The flowchart 600 may then re-display the first GUI 603.

The selected element is checked 611 to determine if the first selected element was selected. If it was, the flowchart 600 continues with presenting a third GUI 613 on the display. The third GUI includes a plurality of selectable elements that respectively represent types of disasters. A selection of one of the plurality of selectable elements of the third GUI is detected 615 to determine a selected type of disaster, and at least one pre-defined field is determined 617 for use in a second GUI, based on the selected type of disaster. If the second selectable element of the first GUI was selected, a pre-defined field is determined for the violence event.

The flowchart 600 continues by presenting a second GUI 619 on the display. The second GUI includes the at least one pre-defined field for user input that is customized to the selected element, that is the disaster event or the violence event. The information about an event entered into the second GUI is collected 623. In some embodiments, a location field is presented in the second GUI and location information entered into the location field is collected and included in the collected information. In some embodiments, one or more beacon signals and/or GPS signals are received 621 through an antenna coupled to the processor. First location information based on the received beacon signals and second location information based on the received GPS signal are determined, and the first location information or second location information is included in the collected information

The collected information is sent 625 over a network coupled to the processor, such as the internet. In some embodiments, a confirmation message or status message is received 627 through the network. The confirmation message is in response to the sending of the collected information, but the status message may not be in response to the sending of the collected information. The confirmation or status message is then presented 629 either visually or audibly. In some embodiments, the first GUI is then presented again 603.

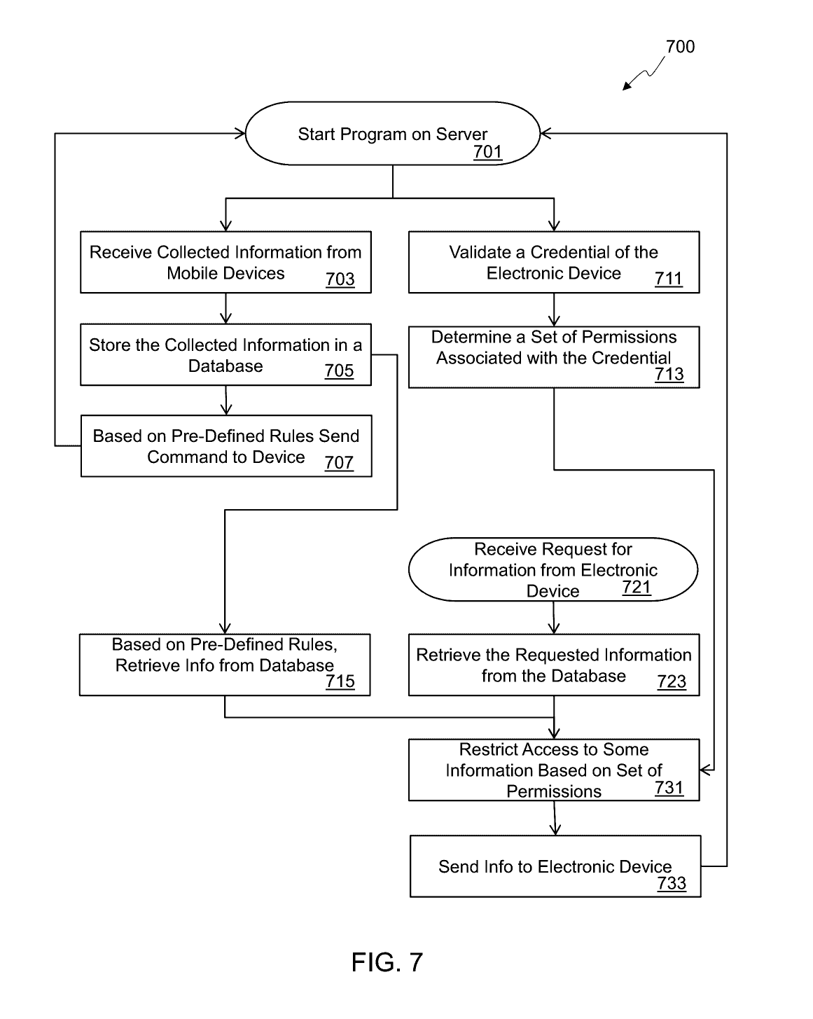

FIG. 7 is a flowchart 700 of an embodiment of a server application. The server application can be stored on a non-transitory computer-readable medium. The instructions of the server application, when executed by a processor, cause the processor to perform the operations shown in the flowchart 700. The server application may be executed by a processor of a server computer, such as the computer 300 shown in FIG. 3.

The flowchart 700 begins when the program is started on the server 701 and continues with multiple flows which may correspond to threads of an application, multiple processes, or separate concurrently running programs. In one flow, collected information is received 703 from reporter applications running on mobile devices. In an alternative embodiment, the collected information could come from a web server that presented web pages on a mobile electronics device using a browser. The collected information is stored in a database 705 that may be local or remote to the server. In some embodiments, pre-defined rules are used to evaluate the received information, and based on the evaluation, commands are sent to a device 707, such as a siren, a door lock, or an emergency lighting system. In some embodiments, another set of pre-defined rules are used to retrieve information from the database 715. Multiple different sets of rules may be used to retrieve information for multiple different incident management applications.

In some embodiments, a request for information is received 721 from an incident manager application running on an electronic device. The requested information is then retrieved from the database 723.

In another part of the flowchart in some embodiments, a credential is received from an electronic device over the network, and the credential is validated 711. Based on the validation, a set of permissions are determined 713 that are associated with the credential. Access to the retrieved information is restricted 731 based on the set of permissions associated with the incident manger that provided the credential. The unrestricted retrieved information is then sent 733 to the incident manager application running on the electronic device.

FIG. 8 is a flowchart 800 of an embodiment of the incident manager application. The incident manager application can be stored on a non-transitory computer-readable medium. The instructions of the incident manager application, when executed by a processor, cause the processor to perform the operations shown in the flowchart 800. The incident manager application may be executed by a processor of an electronic device, such as the mobile electronics device 200 shown in FIG. 2 or the computer 300 shown in FIG. 3.

The flowchart 800 begins when the incident manager program is started 801 on the electronic device. In some embodiments, the flowchart 600 includes sending a credential 803 to a server over the network, and/or sending a request for the information about the event 805 through the network to a server. The request may occur prior to the receiving of information about the event or after some information about the event has been received, depending on the embodiment. The flowchart 800 continues with receiving information about an event 807 through a network coupled to the processor. The event is a disaster event or a violence event, and the received information includes location information. In some embodiments, a set of permissions associated with the credential is received from the server, and access to at least one operation defined by the instructions of the incident manager application is restricted based on the set of permissions.

In some embodiments, a GUI is presented 811 to receive user input through a human input device, such as a touchscreen or a mouse, coupled to the processor. The GUI may have an element to determine whether the retrieved information is displayed in a tabular or cartographic format, an element to confirm reception of information, an element to send a status message, or an element to send a command to control a device. Once a selection on the GUI is detected 813, the selection is evaluated 815 and various operations may then occur, depending on the user input and the embodiment.

In some embodiments, a user input selects whether the first portion of the retrieved information is displayed in the tabular format 825 on a display coupled to the processor. If a user input selects a map, or cartographic format, location information may be translated into a cartographic presentation 821. In various embodiments, this may include translating the user entered data to a first position in the cartographic format, translating the beacon identifier to a second position in the cartographic format, and translating the GPS coordinates to a third position in the cartographic format. Once the location information has been translated into a cartographic format, at least a second portion of the information is displayed in a cartographic format 823 on the display, based at least in part on the location information, which may have been translated. This may include displaying a representation of at least a portion of the first set of data at the first position in the cartographic format on the display, displaying a representation of at least a portion of the second set of data at the second position in the cartographic format on the display, and displaying a representation of at least a portion of the third set of data at the third position in the cartographic format on the display. In some embodiments, the display is a virtual reality or an augmented reality display device, and the cartographic format includes at least one object placed at a virtual location, based on the location information, of the virtual reality or augmented reality display device.

If a selection of the confirmation element is detected, a confirmation message is sent 833 to an originator device of at least a portion of the information. If an element is selected to send a status message, a status message regarding the event is broadcast 835 over the network. And if a selection to send a command is detected, a command is sent to one or more controlled devices 831. The one or more controlled devices may include a siren, a flashing light, a door lock, a gas shut-off valve, a fire suppression system, or an emergency lighting system, and in some cases at least one of the one or more controlled devices is located in proximity to a source of at least some of the information. In at least one embodiment, the one or more controlled devices include a door lock on a door of a room where the originator of the information is located.

As will be appreciated by those of ordinary skill in the art, aspects of the various embodiments may be embodied as a system, method, or computer program product. Accordingly, aspects of embodiments may take the form of an entirely hardware embodiment, an entirely software embodiment (including firmware, resident software, micro-code, or the like) or an embodiment combining software and hardware aspects that may all generally be referred to herein as a “server,” “circuit,” “PC,” “module,” “smartphone,” “tablet,” “auxiliary device,” “logic” or “system.” Furthermore, aspects of the various embodiments may take the form of a computer program product embodied in one or more computer readable medium/media having computer readable program code stored thereon.

Any combination of one or more computer readable storage medium/media may be utilized. A computer readable storage medium may be embodied as, for example, an electronic, magnetic, optical, electromagnetic, infrared, or semiconductor system, apparatus, or device, or other like storage devices known to those of ordinary skill in the art, or any suitable combination of computer readable storage media described herein. In the context of this document, a computer readable storage medium may be any tangible, non-transitory, medium that can contain, or store, a program and/or data for use by or in connection with an instruction execution system, apparatus, or device. In contrast, a computer readable communication medium may be embodied as a transmission line, wireless communication medium, or other communication medium. For the purposes of this disclosure, including the claims, a non-transitory computer readable medium can include any number of computer readable storage media but does not include a computer readable communication medium.

Computer program code for carrying out operations for aspects of various embodiments may be written in any combination of one or more programming languages, including an object oriented programming language such as Java, Smalltalk, C++, or the like, and conventional procedural programming languages, such as the “C” programming language or similar programming languages. In accordance with various implementations, the program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of various embodiments are described with reference to flowchart illustrations and/or block diagrams of methods, apparatus, systems, and computer program products according to various embodiments disclosed herein. It will be understood that various blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the figures help to illustrate the architecture, functionality, and operation of possible implementations of systems, methods, and computer program products of various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the various embodiments provided above is illustrative in nature and is not intended to limit embodiments, its application, or uses. Thus, different variations beyond those described herein are intended to be within the scope of the embodiments of the disclosure. Such variations are not to be regarded as a departure from the intended scope of the present disclosure. As such, the breadth and scope of the present disclosure should not be limited by the above-described embodiments, but should be defined only in accordance with the following claims and equivalents thereof.

Unless otherwise indicated, all numbers expressing quantities of elements, optical characteristic properties, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing various principles of the present disclosure. Recitation of numerical ranges by endpoints includes all numbers subsumed within that range (e.g. 1 to 5 includes 1, 2.78, π, and 5). As used in this specification and the appended claims, the singular forms “a”, “an”, and “the” include plural referents unless the content clearly dictates otherwise. Thus, for example, reference to an element described as “an element” may refer to a single element, two elements, or any other number of elements. As used in this specification and the appended claims, the term “or” is generally employed in its “and/or” inclusive sense, which includes the case where all the elements are included, unless the content clearly dictates otherwise. As used herein, the term “coupled” includes direct and indirect connections. Moreover, where first and second devices are coupled, intervening elements including active elements may be located there between. Any element in a claim that does not explicitly state “means for” performing a specified function, or “step for” performing a specified function, is not to be interpreted as a “means” or “step” clause as specified in 35 U.S.C. §112(f).

The description of the various embodiments provided above is illustrative in nature and is not intended to limit the present invention, its application, or uses. As such, the breadth and scope of the present invention should not be limited by the above-described embodiments, but should be defined only in accordance with the following claims and equivalents thereof.

What is claimed is:

1. A computer-based method of collecting, organizing, and distributing data related to an emergency situation, the method comprising:
presenting a first graphical user interface (GUI) on a first mobile electronic device, the first GUI including at least a first selectable element to provide information about a disaster event and a second selectable element to provide information about a violence event;
detecting a selection of the first selectable element or the second selectable element of the GUI to determine a selected element;
presenting a second GUI on the first mobile electronic device, the second GUI including at least one pre-defined field for user input that is customized to the selected element;
collecting information about an event entered into the second GUI;
sending the collected information to a server over a network connection from the first mobile electronic device;
receiving the collected information from the first mobile electronic device at the server;
storing, by the server, the collected information from the first mobile electronic device in a database with other information about the event received by the server from other mobile electronic devices to create merged information;
retrieving, by the server, at least a portion of the merged information from the database to create retrieved information;
sending the retrieved information from the server to a second electronic device;
receiving the retrieved information at the second electronic device;
displaying at least a first portion of the retrieved information in a first format on the second electronic device; and
displaying at least a second portion of the retrieved information in a second format on the second electronic device;
wherein the first portion of the retrieved information and the second portion of the retrieved information have at least one piece of information in common.

2. The method of claim 1, further comprising:
determining the at least the portion of the merged information to retrieve based on pre-defined rules provided to the server.

3. The method of claim 1, wherein the collected information includes location information, the first format comprises a tabular presentation of the first portion of the retrieved information, and the second format comprises a cartographic presentation of the second portion of the retrieved information, based at least in part on the location information.

4. The method of claim 1, further comprising:
presenting a fourth GUI having a selectable confirmation element on a display of the second electronic device;
detecting, by the second electronic device, a selection of the confirmation element;
sending a confirmation message from the second electronic device to the first mobile electronic device;
receiving the confirmation message at the first mobile electronic device; and
presenting an indication, by the first mobile electronic device, that the confirmation message was received.

5. The method of claim 1, further comprising:
broadcasting a status message regarding the event from the second electronic device;
receiving the status message at the first mobile electronic device and at least one of the other mobile electronic devices; and
presenting the status message at the first mobile electronic device.

6. The method of claim 1, further comprising sending a command from the server to one or more controlled devices in response to receiving the collected information, the command based on pre-defined rules provided to the server.

7. The method of claim 6, wherein the one or more controlled devices comprise a door lock on a door of a room where the first mobile electronic device is located.

8. The method of claim 1, further comprising:
sending a credential from the second electronic device to the server;
validating the credential at the server;
determining a set of permissions associated with the credential; and
restricting access to at least some of merged information based on the set of permissions.

9. A non-transitory computer-readable medium having instructions stored thereon that, when executed by a processor, cause the processor to perform operations comprising:
presenting a first graphical user interface (GUI) on a display coupled to the processor, the first GUI including at least a first selectable element to provide information about a disaster event and a second selectable element to provide information about a violence event;
detecting a selection of the first selectable element or the second selectable element of the GUI to determine a selected element;
presenting a second GUI on the display, the second GUI including at least one pre-defined field for user input that is customized to the selected element;
collecting information about an event entered into the second GUI; and
sending the collected information over a network coupled to the processor.

10. The non-transitory computer-readable medium of claim 9, the operations further comprising:
presenting a third GUI on the display in response to the detection of the selection of the first selectable element, the third GUI including a plurality of selectable elements that respectively represent types of disasters;
detecting a selection of one of the plurality of selectable elements of the third GUI to determine a selected type of disaster; and
determining the at least one pre-defined field of the second GUI based on the selected type of disaster.

11. The non-transitory computer-readable medium of claim 9, wherein the first GUI includes a third selectable element to dial a pre-defined emergency number, the operations further comprising:
initiating a voice communication session to the pre-defined emergency number using a wireless communication interface coupled to the processor in response to a selection of the third selectable element of the first GUI.

12. The non-transitory computer-readable medium of claim 9, the operations further comprising:
presenting a location field in the second GUI;
collecting location information entered into the location field; and
including the location information in the collected information.

13. The non-transitory computer-readable medium of claim 9, the operations further comprising:
receiving one or more beacon signals through an antenna coupled to the processor;
determining first location information based on the received beacon signals;
receiving a GPS signal through an antenna coupled to the processor;
determining second location information based on the received GPS signal; and
including the first location information or second location information in the collected information.

14. A non-transitory computer-readable medium having instructions stored thereon that, when executed by a processor, cause the processor to perform operations comprising:
receiving information about an event through a network coupled to the processor, wherein the event is a disaster event or a violence event and the received information includes location information;
displaying at least a first portion of the information in a tabular format on a display coupled to the processor; and
displaying at least a second portion of the information in a cartographic format on the display, based at least in part on the location information.

15. The non-transitory computer-readable medium of claim 14, the operations further comprising sending a request for the information about the event through the network to a server prior to the receiving.

16. The non-transitory computer-readable medium of claim 14, wherein the second portion of the received information includes a first set of data comprising a first location identified by user-entered data, a second set of data comprising a second location identified by a beacon identifier, and a third set of data comprising a location identified by GPS coordinates generated from GPS signals, the operations further comprising:
translating the user entered data to a first position in the cartographic format;
displaying a representation of at least a portion of the first set of data at the first position in the cartographic format on the display;
translating the beacon identifier to a second position in the cartographic format;
displaying a representation of at least a portion of the second set of data at the second position in the cartographic format on the display;
translating the GPS coordinates to a third position in the cartographic format; and
displaying a representation of at least a portion of the third set of data at the third position in the cartographic format on the display.

17. The non-transitory computer-readable medium of claim 14, the display comprising a virtual reality or an augmented reality display device, and the cartographic format comprising at least one object placed at a virtual location, based on the location information, of the virtual reality or augmented reality display device.

18. The non-transitory computer-readable medium of claim 14, the operations further comprising:
receiving an input through a human input device coupled to the processor; and
sending a command to one or more controlled devices based on the input.

19. The non-transitory computer-readable medium of claim 18, wherein the one or more controlled devices comprise a siren, a flashing light, a door lock, a gas shut-off valve, a fire suppression system, or an emergency lighting system.

20. The non-transitory computer-readable medium of claim 19, wherein at least one of the one or more controlled devices is located in proximity to a source of at least some of the information.
